(19) United States
(12) Patent Application Publication
(10) Pub. No.: US 2012/0297293 A1
(43) Pub. Date: Nov. 22, 2012

(54) DOCUMENT CONVERSION APPARATUS, INFORMATION PROCESSING METHOD, AND STORAGE MEDIUM

(75) Inventor: Tomoyuki Furuya, Tokyo (JP)

(73) Assignee: CANON KABUSHIKI KAISHA, Tokyo (JP)

(21) Appl. No.: 13/460,165

(22) Filed: Apr. 30, 2012

(30) Foreign Application Priority Data
May 16, 2011 (JP) 2011-109515

(51) Int. Cl. G06F 17/00

(52) U.S. Cl. 715/239

(57) ABSTRACT

A document conversion apparatus determines whether a response indicating that conversion has been completed is received from an application within time set to a page mode timer corresponding to a page mode, and if no response indicating that conversion has been completed is received from the application within the time set to the page mode timer, forcibly terminates a process of the application.

### BACKGROUND OF THE INVENTION

1. Field of the Invention

The present invention relates to a document conversion apparatus, an information processing method, and a program.

2. Description of the Related Art

Conventionally, a filter pipeline system is a processing method for connecting a plurality of detachable modules, i.e., filters, using a pipeline. The filters receive and transmit data between each other employing various methods, such as by sequentially transmitting the data in a stream, or collectively transmitting the data as an electronic file. The methods for receiving and transmitting the data are similar in that output data of a filter becomes input data of a subsequent filter.

An example of the conventional filter pipeline system is Microsoft Extensible Markup Language (XML) Paper Specification (XPS) filter pipeline (refer to non-patent literature 1 (“XPSDrv_FilterPipe.xps” [online], Feb. 7, 2008, http://msdn.microsoft.com/ja-jp/windows/hardware/gg463364.a spx on the Internet)).

Microsoft XPS filter pipeline includes an XPS layout filter which converts a layout of an XPS file, i.e., an input format, and outputs an XPS file whose layout has been converted.

Further, Microsoft XPS filter pipeline includes an XPS print filter which converts the laid out XPS file to a page description language (PDL) file which is a control command recognizable by a printing apparatus.

However, if there is no response on a format conversion instructed to an application within a predetermined period of time, the filter pipeline system cannot determine whether the conversion process is too heavy, or an error has occurred while the application has been performing the conversion processing.

If the conversion processing is heavy due to a large number of pages in the input document, it is appropriate for the filter pipeline system to wait further for a predetermined period of time to receive the response. In contrast, if the filter pipeline system waits further when there occurs an error, the system becomes unable to operate for the predetermined period of time.

If there occurs an error, it is appropriate to end the application process and perform error processing of the conversion processing. However, if the conversion processing is simply heavy, it results in that the input document cannot be converted to the output document.

### SUMMARY OF THE INVENTION

The present invention is directed to a document conversion apparatus, an information processing method, and a storage medium capable of correcting a failure and an error in a process in a short period of time, even when an error has occurred in the application and there is no response.

According to an aspect of the present invention, a document conversion apparatus including a document conversion processing unit configured to control an application that converts a document, the document conversion processing unit includes a job mode instruction unit configured to instruct an application to perform conversion in a job mode in which an entire document is collectively converted, an application control unit configured to activate a process of an application and determine whether a response indicating that conversion has been completed is received from the application within a time set to a job mode timer corresponding to the job mode, and a page mode instruction unit configured to instruct, when the application control unit determines that no response indicating that conversion has been completed is received from the application within the time set to the job mode timer, the application to perform conversion in a page mode in which the entire document is converted page by page to a document corresponding to a number of pages, wherein the application control unit further determines whether a response indicating that conversion has been completed is received from the application within a time set to a page mode timer corresponding to the page mode, and when no response indicating that conversion has been completed is received from the application within the time set to the page mode timer, forcibly terminates a process of the application.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1A illustrates an example of a document conversion filter performing document conversion using an application, and FIG. 1B illustrates an example of the document conversion filter performing document conversion using a portable document format (PDF) generation driver.

FIG. 2 illustrates an example of a configuration of a computer to which a format conversion apparatus is applied.

FIG. 3 is a schematic diagram illustrating a process from receiving a document conversion instruction to performing printing.

FIG. 4 illustrates an example of a software configuration of a format conversion unit.

FIG. 5 illustrates an example of a configuration of a document conversion filter 15.

FIG. 6A illustrates an example of a job mode which is a conversion method performed by a document conversion job mode instruction unit, FIG. 6B illustrates an example of a page mode which is a conversion method performed by a document conversion page mode instruction unit, FIG. 6C illustrates an example of an output result in the job mode, and FIG. 6D illustrates an example of an association document.

FIG. 7A illustrates an application control unit constantly monitoring a response time with respect to an instruction issued to an application, and FIG. 7B illustrates an example of a job mode timer and a page mode timer.

FIG. 8 is a flowchart illustrating an example of a process performed in the job mode according to a first exemplary embodiment.

FIG. 9 is a flowchart illustrating an example of a process performed in the page mode according to the first exemplary embodiment.

FIG. 10 is a flowchart illustrating information processing by simplifying the flowcharts illustrated in FIGS. 8 and 9.

FIG. 11 illustrates an example of a plurality of document conversion filters controlling a conversion application which operates on the same process.

FIG. 12A illustrates an example of shared information, FIG. 12B illustrates examples of the job mode timer and the page mode timer, and FIG. 12C illustrates an example of conditions for performing transition between the job mode and the page mode.

FIG. 13 is a flowchart illustrating an example of a process performed in the job mode according to a second exemplary embodiment.

FIG. 14 is a flowchart illustrating an example of a process performed in the page mode according to the second exemplary embodiment.

### DESCRIPTION OF THE EMBODIMENTS

Various exemplary embodiments, features, and aspects of the invention will be described in detail below with reference to the drawings.

The input format of the filter pipeline system is not necessarily fixed. The input format may be an arbitrary format, such as a PDF format or Office Open (OO) XML employed in Microsoft Office® applications.

If the filter pipeline system can deal with various formats, a format can be converted to a format interpretable by a subsequent filter, using a commercially available application that can interpret the format.

For example, it is assumed that the input format of the filter pipeline system is OOXML and the output format of the filter pipeline system is PDL, and that the filter pipeline previously includes a PDF print filter which converts the PDF format to PDL. In such a case, an OOXML-PDF conversion filter is connected to the PDF print filter.

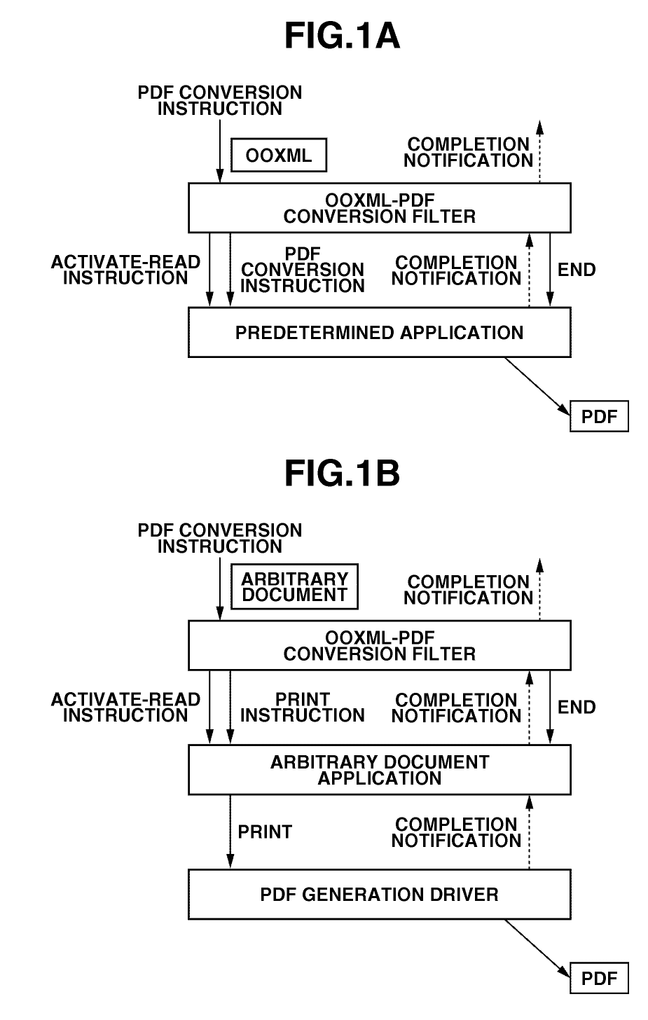

FIG. 1A illustrates an example in which OOXML is input to the OOXML-PDF conversion filter. The OOXML-PDF conversion filter then activates a process of the Microsoft Office application (hereinbelow, referred to as a predetermined application) and instructs the application to perform PDF conversion. The OOXML-PDF conversion filter thus outputs the generated PDF format. If the application does not include a function for directly converting the PDF format, a similar function may be realized as long as the application includes a print function.

As illustrated in FIG. 1B, a PDF generation driver that outputs the PDF format is employed instead of a printer driver. In such a case, the application instructs the PDF generation driver to perform printing. The PDF format is thus acquired as an output from the PDF generation driver.

As described above, the filter pipeline system can deal with various formats by configuring the document conversion filter by utilizing an application, and combining with the filter that corresponds to the input format.

The filter pipeline system can judge that the input format is OOXML, and convert it into the PDF format by utilizing the OOXML-PDF conversion filter. However, as described above, the filter pipeline system cannot sequentially monitor whether the predetermined application of which process is activated by the OOXML-PDF conversion filter is normally performing OOXML-PDF conversion.

To solve such a problem, according to a first exemplary embodiment of the present invention, a format conversion apparatus is applied to a client personal computer (PC) in the filter pipeline system. According to the first exemplary embodiment, input documents are formatted and processed, and filters structured by the filter pipeline system are switched according to the format of the input document.

More specifically, the filter converts the format of an arbitrary input document into the PDF format using the application which can interpret the input format. Further, the subsequent filter converts the PDF format to a PDL file, i.e., print data.

As described above, a filter control unit in the filter pipeline system combines a plurality of filters and realizes a desired process.

According to the present exemplary embodiment, the format to be converted by utilizing the application is not limited to the PDF format, and a similar result may be acquired as long as the format is interpretable by the subsequent filter.

Further, it is not necessary for the subsequent filter to output a PDL file, and the present exemplary embodiment is not limited to the printing system. The present invention is applicable to a use case in which a document is output. Furthermore, the format conversion apparatus according to the present exemplary embodiment is applicable to cases where a service is provided, such as a web service server or a cloud service.

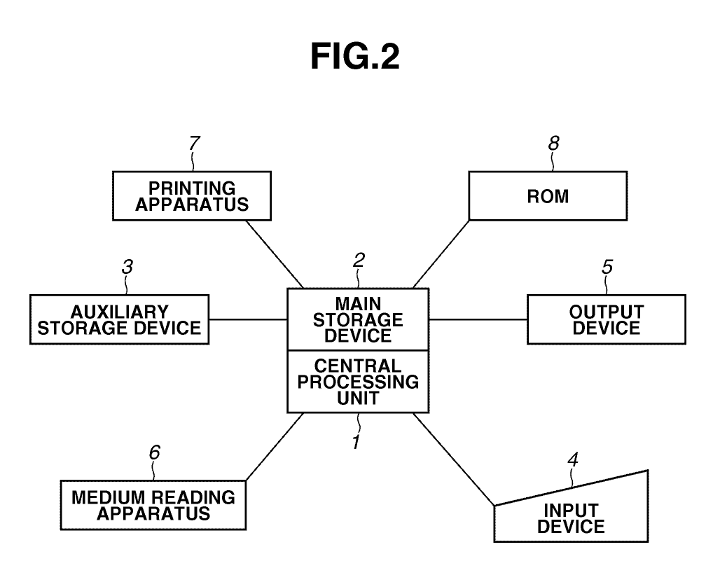

FIG. 2 illustrates an example of a configuration of the computer to which the format conversion apparatus is applied.

Referring to FIG. 2, a central processing unit (CPU) 1 reads from a medium reading apparatus 6 connected to the system, programs and data stored in a recording medium such as a floppy disk (FD), a compact disk (CD)-read-only memory (ROM), and an integrated circuit (IC) memory card. The CPU 1 then processes using a system program and an application program loaded from an auxiliary storage device 3 to a main storage device 2, information input from an input device 4. The CPU outputs the processed information to an output device 5 or a printing apparatus 7. According to the present exemplary embodiment, the output device 5 is a display device, and is different from the printing apparatus 7 included in the system as the output device.

Further, the input device 4 includes a keyboard and a pointing device. Further, the auxiliary storage device 3 may include a hard disk and a magnetic optical disk, or a combination of both. Further, each of the devices may be connected via a network.

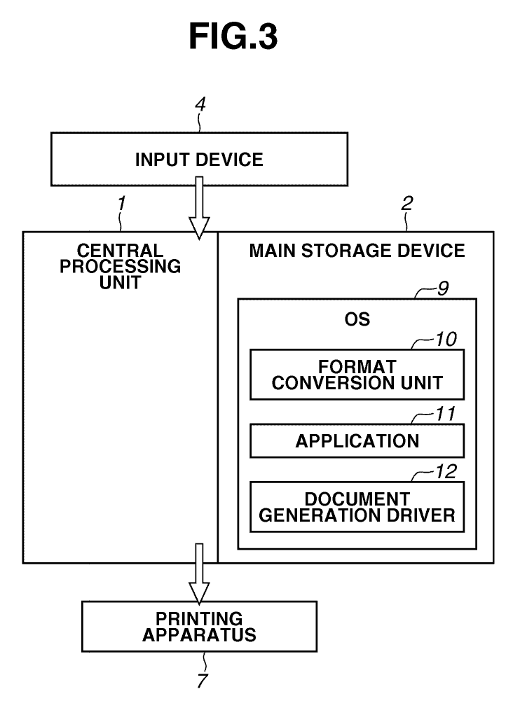

FIG. 3 is a schematic diagram illustrating a process performed as follows. The CPU 1 reads the program and the related data stored in the medium reading apparatus 6. The input device 4 then inputs to a format conversion unit 10 a format conversion instruction, and the PDL data is transmitted to the printing apparatus 7. The format conversion unit 10 utilizes an application 11 and a document generation driver 12 which function under control of an operation system (OS) 9.

Referring to FIG. 3, the format conversion unit 10, the application 11, and the document generation driver 12 are programs. As described above, the CPU 1 executes the programs and function the programs as the format conversion unit 10, the application 11, and the document generation driver 12, i.e., software.

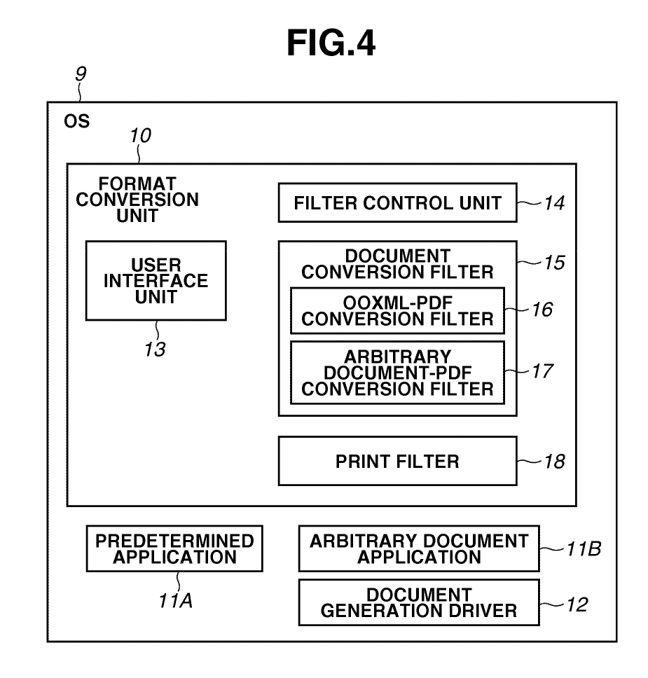

FIG. 4 illustrates an example of the software configuration of the format conversion unit 10. Referring to FIG. 4, the OS 9 interprets the format conversion unit 10, a predetermined application 11A, and the input document. The OS 9 also controls an arbitrary document application 11B capable of printing, and the document generation driver 12.

A user interface unit 13 is used by a user to input, to the format conversion unit 10, designations and various settings on a document to be converted, and a conversion start instruction. A filter control unit 14 constructs a processing order of the various filters and controls input and output, according to the instructions from the user.

A document conversion filter 15 indicates a document conversion filter group which particularly includes a document conversion function among the filters. According to the present exemplary embodiment, the document conversion filter 15 does not actually exist, and is a generic term that includes the filters which covert the input document to another document. For example, an OOXML-PDF conversion filter 16, i.e., an example of the document conversion filter 15, acquires the OOXML file, activates and causes the process of the predetermined application 11A to read the acquired OOXML file, and issues the PDF conversion instruction. The PDF file generated by the predetermined application 11A is output from the OOXML-PDF conversion filter 16.

Further, another example of the document conversion filter 15 is an arbitrary document PDF conversion filter 17. According to the present exemplary embodiment, an arbitrary document may be of a standard format such as the XPS and OpenDocument Format (ODF), or of a document format used in only a specific application.

The arbitrary document application 11B which processes the arbitrary document is not a single application, and is a generic term that includes a plurality of various applications. According to the present exemplary embodiment, a mechanism which associates a file extension provided by the OS with an application is employed. It is thus not necessary for the document conversion filter 15 to be aware of the application to be activated.

The arbitrary document PDF conversion filter 17 acquires the input document file, activates the process of the arbitrary document application 11B, and causes the arbitrary document application 11B to read the acquired input document. The arbitrary document PDF conversion filter 17 then designates the document generation driver 12, which is to generate the PDF format, and issues a print instruction. The PDF format generated by the document generation driver 12 becomes the output from the arbitrary document PDF conversion filter 17.

A print filter 18 generates the PDL data to be used in printing, based on the PDF format generated from the various document files by the document conversion filter 15. The generated PDL data is then input to the printing apparatus 7, so that the PDL data is printed on a paper.

According to the present exemplary embodiment, the print filter constantly converts the PDF format to the PDL format. However, the input is not limited to the PDF format, and the present invention may be applied to another format, such as by using an XPS print filter to convert the XPS format to the PDL format. In such a case, the output from the document conversion filter 15 is to be the input format of the print filter 18.

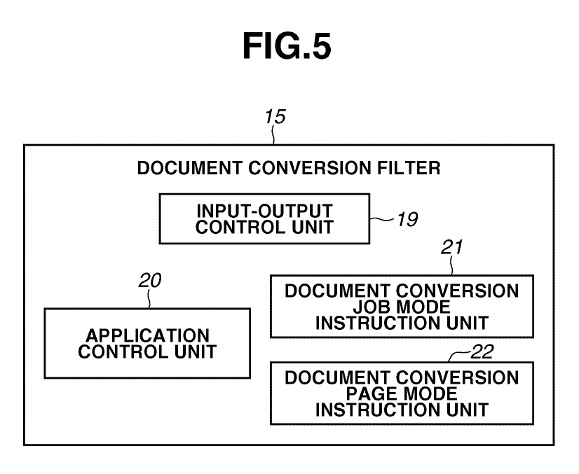

FIG. 5 illustrates an example of a configuration of the document conversion filter 15. Referring to FIG. 5, the document conversion filter 15 includes an input-output management unit 19, an application control unit 20, a document conversion job mode instruction unit 21, and a document conversion page mode instruction unit 22.

The input-output management unit 19 transfers to the document conversion job mode instruction unit 21 or the document conversion page mode instruction unit 22 the input document which has been input to the document conversion filter 15. The input-output management unit 19 acquires the converted output document and manages input and output of the acquired document as an output from the document conversion filter 15.

The application control unit 20 activates the application capable of interpreting the input document, and ends the process of the application after the processing is completed. Further, the application control unit 20 monitors the response from the application, and if there is no response during a predetermined period of time, the application control unit 20 determines that an error has occurred in the application, and performs an appropriate processing. Such an appropriate processing according to the present exemplary embodiment will be described below.

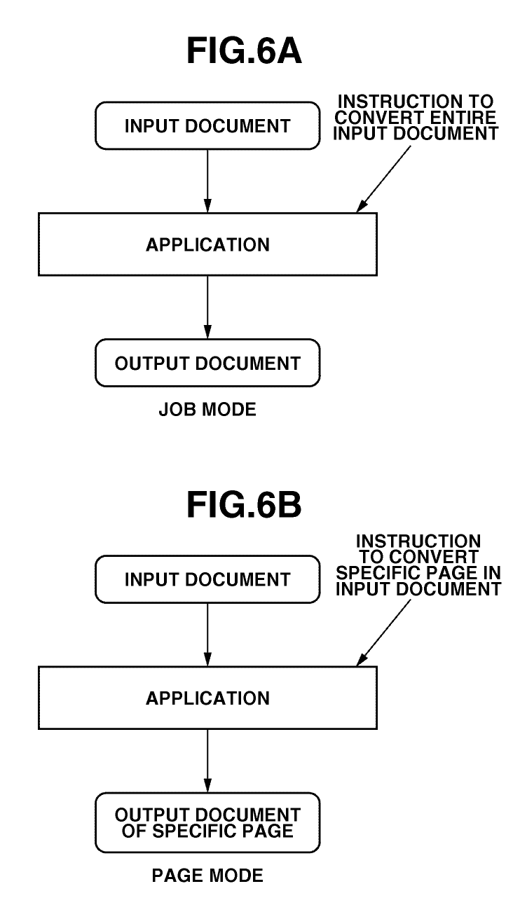

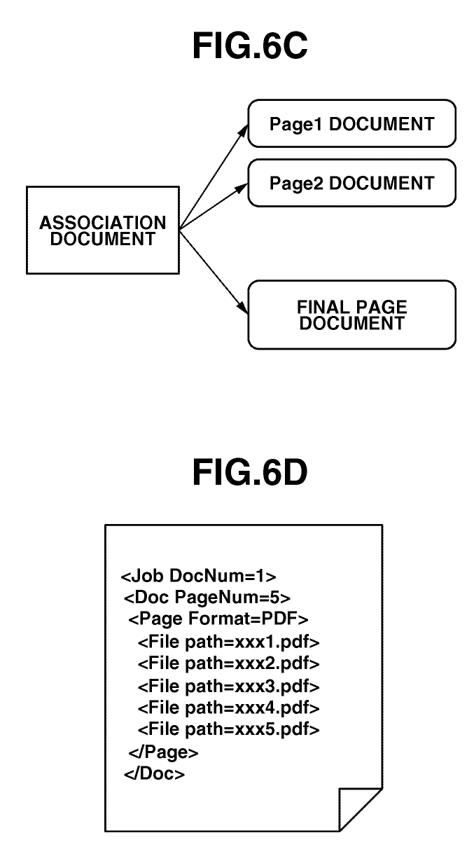

The document conversion job mode instruction unit 21 uses the application to directly convert the input document to the output document (i.e., collectively converts the entire input document). The document conversion page mode instruction unit 22 coverts the input document to the output document corresponding to one page of the document for the number of pages in the document. Such conversion processing will be described below with reference to FIGS. 6A, 6B, 6C, and 6D.

FIG. 6A illustrates an example of the job mode which is a conversion method performed by the document conversion job mode instruction unit 21. In the case of the job mode, the document conversion job mode instruction unit 21 instructs the application to convert the entire input document to an output document. In other words, one input document is converted to one output document.

FIG. 6B illustrates an example of the page mode which is a conversion method performed by the document conversion page mode instruction unit 22. In the case of the page mode, the document conversion page mode instruction unit 22 designates the page to be converted and instructs the application to convert the designated page to an output document.

The document conversion page mode instruction unit 22 sequentially designates the page from page 1 and updates the designated page one by one, for the number of pages in the input document. The output document for each page is generated for the number of pages in the input document as illustrated in FIG. 6C. Referring to FIG. 6C, a document associates the output documents with each other (i.e., an association document), and designates to which page the output document corresponds to.

FIG. 6D illustrates an example of the association document. According to the present exemplary embodiment, the association document designates a file as a page file in an XML format.

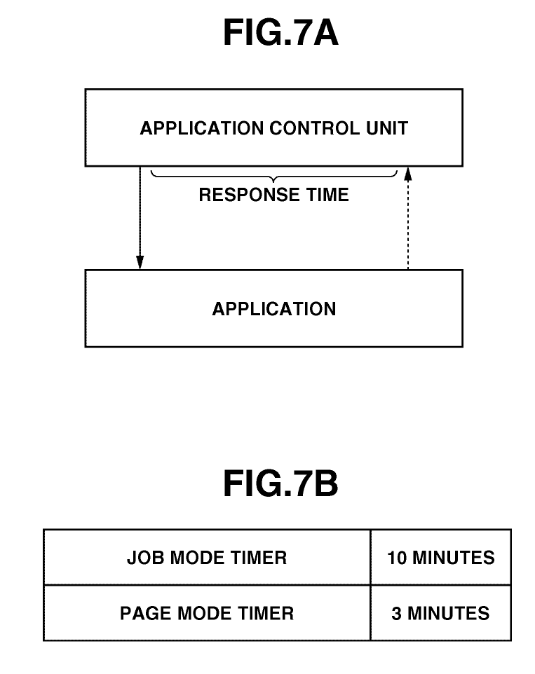

FIG. 7A illustrates the application control unit 20 constantly monitoring the response time with respect to an instruction to the application. Two types of timers are previously prepared as illustrated in FIG. 7B. In the case of the job mode, the application control unit 20 monitors the response from the application based on a job mode timer. If there is no response during a time set to the job mode timer, the application control unit 20 determines that there is an error in the job mode. The conversion mode then shifts to the page mode.

In the case of the page mode, the application control unit 20 monitors the response from the application based on a page mode timer. If there is no response within the time set to the page mode timer, the application control unit 20 determines that there is an error in the page mode. In such a case, it is determined that there is an error in the conversion processing itself.

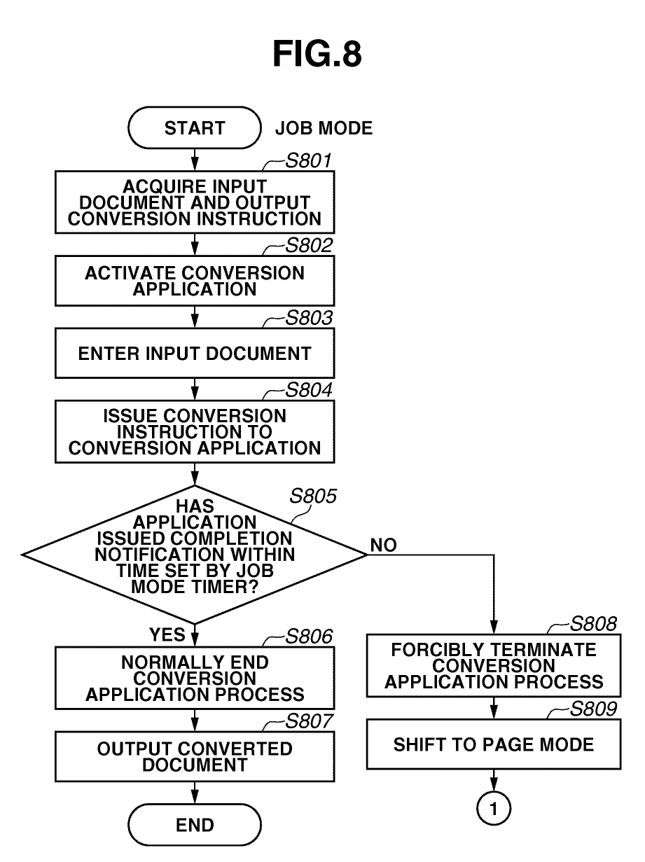

The processing performed by the document conversion filter 15, and in particular in the job mode, according to the present exemplary embodiment will be described below with reference to the flowchart illustrated in FIG. 8. The flowchart starts from when the document conversion filter 15 receives the input document and the output conversion instruction. The processing initially starts in the job mode illustrated in FIG. 6A.

In step S801, the input-output management unit 19 in the document conversion filter 15 acquires the input document and the output conversion instruction. In step S802, the application control unit 20 then activates the application capable of converting the input document to the output document.

In such a case, the application to perform conversion may by a commercially available application. It is necessary for the application to be capable of converting the input document to the output document according to the output conversion instruction, or capable of performing printing using the printer driver which generates the output document.

In step S803, the application control unit 20 causes the activated application to read the input document.

In step S804, since the job mode is currently designated, the document conversion job mode instruction unit 21 instructs the application to directly convert the input document to the output document, or to issue a print instruction to the output document generation printer driver. In such a case, the document conversion job mode instruction unit 21 instructs the application to convert the entire input document to one output document.

The application control unit 20 measures the time for the application to issue a response of completing the processing. Since the current setting is the job mode, the application control unit 20 monitors whether there is a response from the application within the time set to the job mode timer registered as illustrated in FIG. 7B.

In step S805, the application control unit 20 thus determines whether a completion notification has been issued from the application within the time set to the job mode timer. If the application has issued the completion notification within the time set to the job mode timer (YES in step S805), it indicates that the application has normally completed converting to the output document. The processing then proceeds to step S806. In step S806, the application control unit 20 ends the process of the conversion application activated in step S802.

In step S807, the input-output unit 19 outputs from the document conversion filter 15 the output document generated by the conversion application, or the conversion application and the document generation driver 12. The input-output management unit 19 then transfers the output document to the subsequent filter included in the filter pipeline system, and the processing ends.

If the application has not issued the completion notification within the time set to the job mode timer (NO in step S805), it indicates one of the followings. The size of the input document is too large, so that the input document cannot be processed within the short time designated on the job mode timer, or an error has occurred in the application due to inadequacy of the input document.

If the size of the input document is too large, it is appropriate for the application control unit 20 to wait further. If the input document is inadequate, it is unlikely that the conversion processing will be completed even after waiting for a period of time. If the conversion processing is to be performed using a component such as a commercially available application in which internal processing is unclear, the document conversion filter 15 cannot determine which of the above-described cases has occurred. In step S808, the application control unit 20 thus forcibly terminates the process being performed by the conversion application. In step S809, the application control unit 20 shifts the mode from the job mode to the page mode.

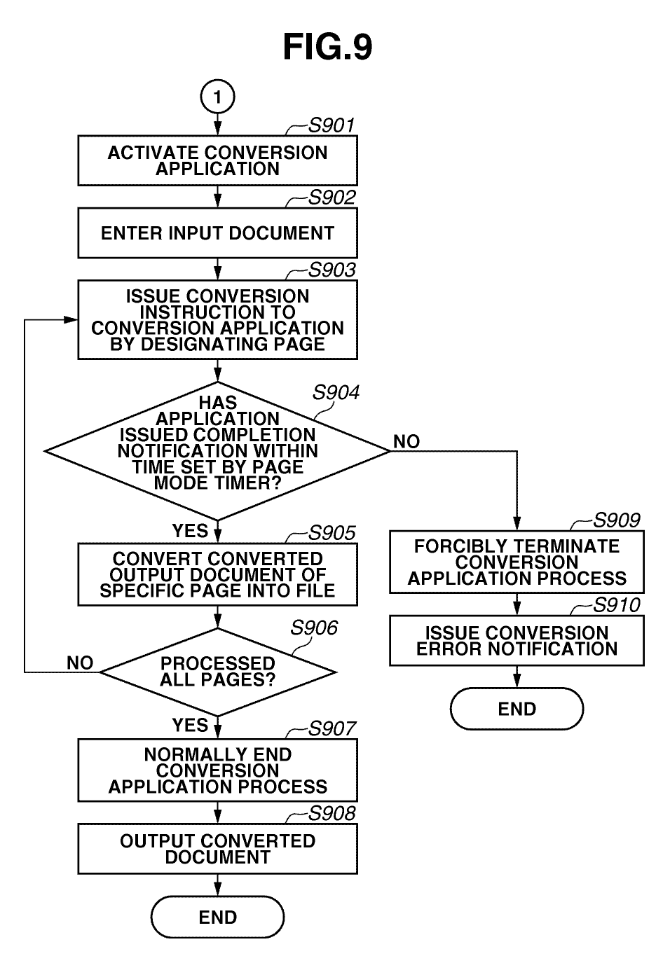

The process performed in the page mode after shifting from the job mode as illustrated in FIG. 8 will be described below with reference to the flowchart illustrated in FIG. 9.

Referring to FIG. 9, the page mode illustrated in FIG. 6B is designated. Further, the input document and the output conversion instruction acquired by the input-output management unit 19 in step S801 illustrated in FIG. 8 can be directly utilized in the process of the flowchart illustrated in FIG. 9.

In step S901, the application control unit 20 activates the application capable of converting the input document. Such conversion application is similar to the application activated in Step S802 illustrated in FIG. 8. In step S902, the application control unit 20 causes the activated application to read the input document.

In step S903, since the page mode is currently designated, the document conversion page mode instruction unit 22 instructs the application to directly convert the input document to the output document, or to issue a print instruction to the output document generation printer driver. In such a case, the document conversion page mode instruction unit 22 issues an instruction to convert one page of the input document to one output document.

The application control unit 20 measures the time for the application to issue a response of completing the processing. Since the page mode is currently designated, the application control unit 20 monitors whether there is a response from the application within the time set to the page mode timer registered as illustrated in FIG. 7B.

In step S904, the application control unit 20 thus determines whether a completion notification has been issued by the application within the time set to the page mode timer. If the application has issued the completion notification within the time set to the page mode timer (YES in step S904), it indicates that the application has normally completed converting the output document. The processing then proceeds to step S905. In step S905, the document conversion page mode instruction unit 22 converts the output document of a designated page into a file. In step S906, the document conversion page mode instruction unit 22 determines whether all of the pages in the input document have been processed.

If not all of the pages in the input document has been processed (NO in step S906), the processing returns to step S903. In step S903, the document conversion page mode instruction unit 22 designates the subsequent page as the page to be converted, and re-instructs converting the designated page to an output document. In step S904, the application control unit 20 performs comparison of the response time with the time set to the page mode timer for each conversion. If the designated page is normally converted, the processing proceeds to step S905 in which the document conversion page mode instruction unit 22 converts the output document into the file. The above-described processes are performed for every page until all pages in the input data have been converted.

In step S906, the application control unit 20 determines whether all of the designated pages has been converted to output documents within the time set to the page mode timer. If all of the designated pages has been converted to the output documents within the time set to the page mode timer (YES in step S906), it indicates that the input document has been normally converted to the output document.

In step S907, the application control unit 20 ends the process of the conversion application activated in step S901. In step S908, the input-output management unit 19 associates the output documents of the designated pages corresponding to the number of pages of the input document, generated by the conversion application or the conversion application and the output document generation printer driver. The input-output management unit 19 associates the output documents of the designated pages as illustrated in FIGS. 6C and 6D. The input-output management unit 19 thus generates the document.

If the application does not issue within the time set to the page mode timer the completion notification for converting the designated page (NO in step S904), it indicates that an error has occurred in the application due to inadequacy of the input document corresponding to a specific page. In such a case, the input document cannot be converted to the output document. The processing then proceeds to step S909.

In step S909, the application control unit 20 forcibly terminates the process of the conversion application. In step S910, the input-output management unit 19 issues a processing error notification indicating that the instructed conversion processing has failed.

According to the above-described processing, conversion of a specific page has failed. However, the previous pages are successfully converted. If the input-output management unit 19 notifies the pages that have been successfully converted and pages that have failed to be converted, the user may be urged to correct the specific page or to instruct skipping processing of the specific page. Further, in such a case, re-conversion may be efficiently performed by utilizing successfully processed page group.

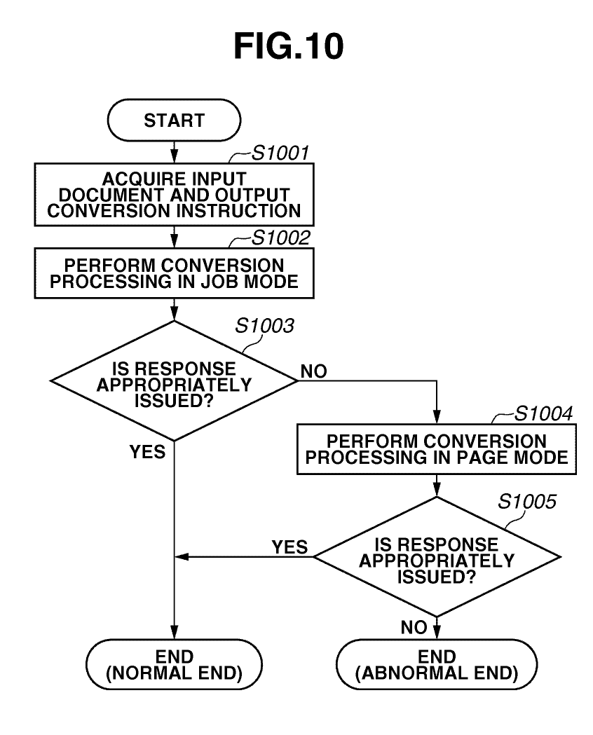

FIG. 10 is a flowchart illustrating information processing by simplifying the series of flowcharts illustrated in FIGS. 8 and 9.

In step S1001, the document conversion filter 15 receives the input document and the instruction to convert the input document to an output document. In step S1002, the document conversion filter 15 performs conversion in the job mode. In step S1003, the application control unit 20 determines whether whole processing have been completed within the time previously set to the timer in the job mode. If the application control unit 20 determines that whole processing have been completed within the time (YES in step S1003), it indicates that the conversion processing has been normally completed, and the processing ends.

If there is processing that has not been completed within the preset time in the job mode (NO in step S1003), the processing proceeds to step S1004. In step S1004, the document conversion filter 15 performs conversion in the page mode. In step S1005, the application control unit 20 determines whether whole processing have been completed within the time previously set to the timer in the page mode. If whole processing has been completed within the preset time in the page mode (YES in step S1005), the document conversion filter 15 normally ends.

On the other hand, if there is processing which has not been completed within the preset time in the page mode (NO in step S1005), it indicates that the document conversion filter 15 has failed in performing document conversion instructed in step S1001.

According to the first exemplary embodiment, one document conversion filter 15 controls activation and ending of the process performed by the conversion application. If a plurality of filter pipeline systems operates in parallel on one OS 9, a plurality of document conversion filters may use one conversion application at the same time.

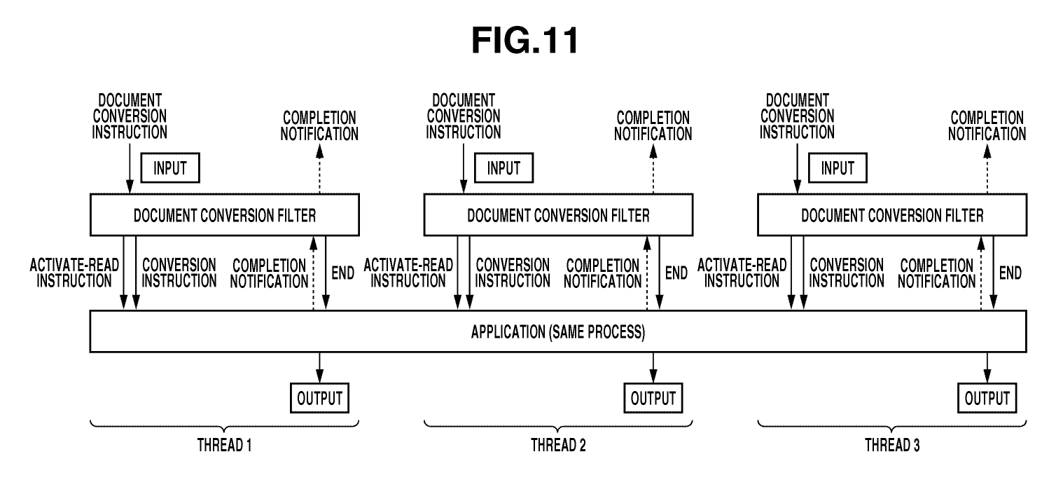

FIG. 11 illustrates an example of the plurality of document conversion filters controlling the conversion application performing the same process.

Referring to FIG. 11, three document conversion filters each covert different input documents to output documents. Each of the three document conversion filters thus instructs activation, ending, and conversion of the application.

A plurality of applications does not actually become activated even when the document conversion filters designate activation of the process. Upon receiving the activation instruction for a second time and after, the application may perform parallel processing by dividing a thread.

In contrast, if one of the document conversion filters forcibly terminates the process, the application process is caused to forcibly terminate even when the other document conversion filters are issuing the conversion instructions. In other words, it becomes similar to a state where the application, to which the other document conversion filters are instructing conversion, suddenly disappears.

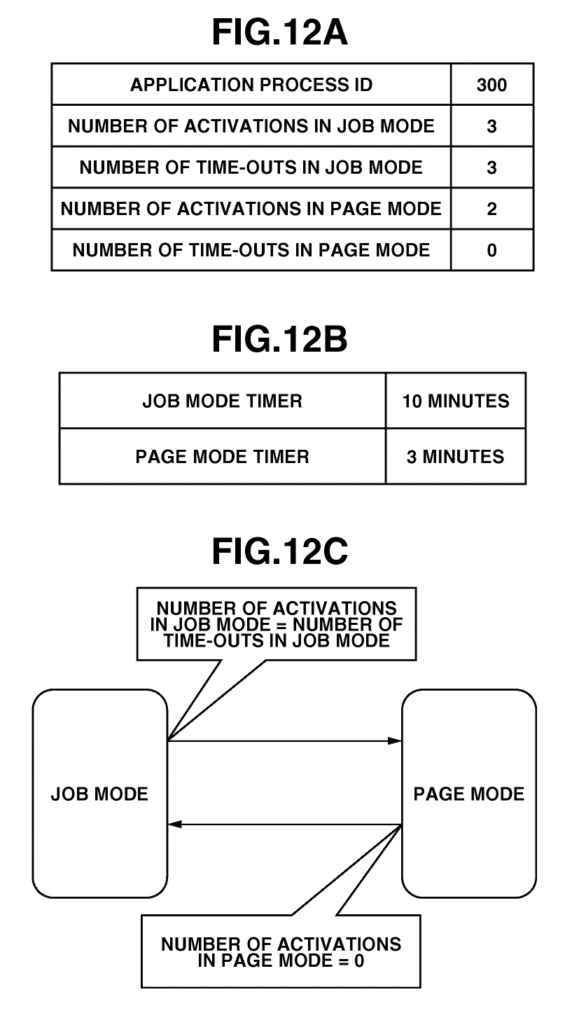

To solve such a problem, the application control unit 20 in the document conversion filter stores shared information as illustrated in FIG. 12A between a plurality of application control units 20. Referring to FIG. 12A, the shared information records the number of times of activation and the number of times of time-out in the job mode and the page mode.

The shared information may be stored as a file in a predetermined location. Alternatively, the shared information may be stored in a registry provided by the OS 9 or a shared memory which is a shared storage area of the plurality of application control units 20.

The shared information is stored for each application process. Further, according to the second exemplary embodiment, if the shared information does not exist, the application control unit 20 in the document conversion filter that initially activates the process generates the shared information.

When the document conversion filter activates the process of the conversion application, the document conversion filter increments, if the mode is the job mode illustrated in FIG. 6A, the count of the number of times of the activation in the job mode by 1. If the conversion is normally completed, the document conversion filter decrements the count of the number of times of the activation in the job mode by 1.

If the count of the number of times of the activation in the job mode becomes 0 as a result of the document conversion filter decrementing by 1, it indicates that the other document conversion filters are not activating the process of the conversion application. The application control unit 20 thus ends the application process when the count of the number of times of the activation in the job mode becomes 0.

A similar processing is performed in the case when the mode is in the page mode as illustrated in FIG. 6B. Upon activating the process of the conversion application, the application control unit 20 increments the count of the number of times of activation in the page mode by 1. When the application has normally completed conversion, the application control unit 20 decrements the count of the number of times of activation in the page mode by 1. When the number of times of activation in the page mode has become 0, the application control unit 20 ends the application process.

If there is no response from the application within the time set to the job mode timer or the page mode timer designated as illustrated in FIG. 12B, the application control unit 20 increments by 1 the count of the number of times of time-out in the job mode or the number of times of time-out in the page mode.

If the number of times of time-out is smaller than the number of times of activation, it indicates that the other document conversion filters are issuing the conversion instruction. As a result, the application control unit 20 waits for the other document conversion filters to reach time-out, even when there is no response and the time has run out.

FIG. 12C illustrates transition between the job mode and the page mode. Referring to FIG. 12C, if the system is operating in the job mode and the number of times of activation in the job mode matches the number of times of time-out in the job mode, the application control unit 20 which has last updated the number of times of time-out in the job mode forcibly terminates the application. The system then shifts to the page mode. The application control unit 20 in the other document conversion filters similarly shifts to the page mode.

When the system is in the page mode, each application control unit 20 increments by 1 the number of times of activation in the page mode every time each of the application control unit 20 activates the conversion application. Further, each application control unit 20 decrements by 1 the number of times of activation in the page mode every time conversion is normally ended. If the number of times of activation in the page mode becomes 0, the application control unit 20 ends the application process. Since the subsequent processing has returned to the initial state, the system operates in the job mode.

If the number of times of time-out in the page mode illustrated in FIG. 12A matches the number of times of activation in the page mode, it indicates that an error has occurred in all of the application control units 20 in the page mode. The application control unit 20, of which numbers are matched last, thus forcibly terminates the conversion application, and all of the document conversion filters indicates that there has been an error in the processing.

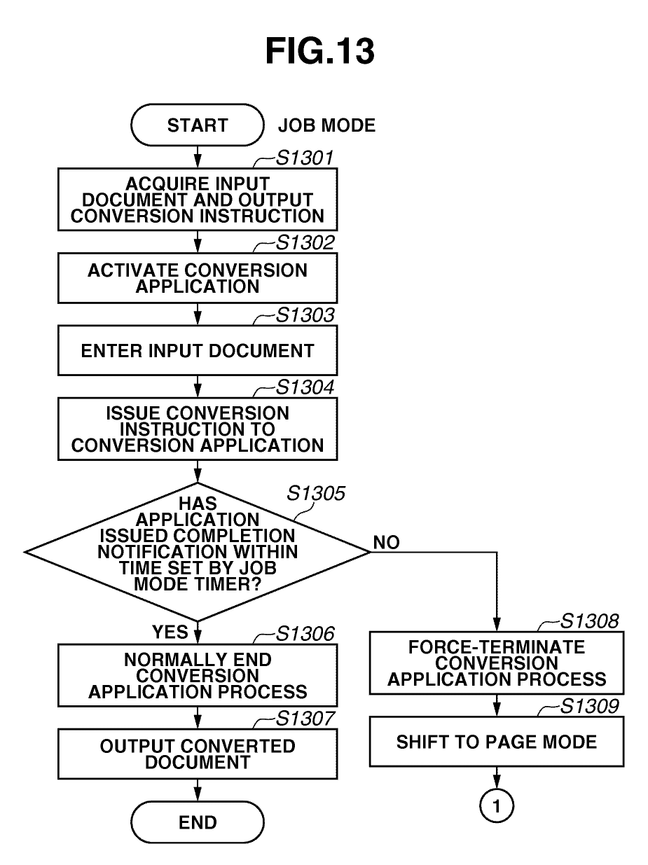

The processing performed by the document conversion filter, and in particular in the job mode, according to the second exemplary embodiment will be described below with reference to a flowchart illustrated in FIG. 13. The flow starts when the document conversion filter receives the input document and the output conversion instruction.

The processing initially starts in the job mode illustrated in FIG. 6A. In step S1301, the input-output management unit 19 in the document conversion filter acquires the input document and the output conversion instruction. In step S1302, the application control unit 20 activates the application capable of converting the input document to the output document.

According to the second exemplary embodiment, the activation process includes the following series of processing, described above with reference to FIGS. 12A, 12B, and 12C.

The application control unit 20 reads process identification (ID) of the application.

The application control unit 20 accesses the shared information illustrated in FIG. 12A using the process ID. If the shared information does not exist, the application control unit 20 newly generates the shared information.

If the number of times of activation in the job mode is 0, the application control unit 20 activates the process of the corresponding application.

The application control unit 20 increments the number of times of the activation in the job mode by one.

In step S1303, the application control unit 20 causes the activated application to read the input document.

In step S1304, since the job mode is currently designated, the document conversion job mode instruction unit 21 instructs the application to directly convert the input document to the output document. In such a case, the document conversion job mode instruction unit 21 instructs to convert the entire input document to one output document.

The application control unit 20 measures the time for the application to issue a response of completing the processing. Since the current setting is the job mode, the application control unit 20 monitors whether there is a response from the application within the time set to the job mode timer registered as illustrated in FIG. 12B.

In step S1305, the application control unit 20 thus determines whether a completion notification has been issued by the application within the time set to the job mode timer. If the application has issued the completion notification within the time set to the job mode timer (YES in step S1305), it indicates that the application has normally completed converting the output document. The processing then proceeds to step S1306.

In step S1306, the application control unit 20 performs a process normal end processing of the conversion application activated in step S1302. According to the second exemplary embodiment, the process normal end processing includes the following series of processing described above with reference to FIG. 12C.

The application control unit 20 decrements the number of times of activation in the job mode by 1.

If the number of times of activation in the job mode becomes 0 by decrementing, the application control unit 20 normally ends the process of the application.

In step S1307, the input-output management unit 19 outputs from the document conversion filter the output document generated by the conversion application, or the conversion application and the output document printer driver. The input-output management unit 19 then transmits the output document to the subsequent filter included in the filter pipeline system, and then the processing ends.

If the application has not issued the completion notification within the time set to the job mode timer (NO in step S1305), it indicates one of the followings. The size of the input document is too large, so that the input document cannot be processed in the short time set to the job mode timer, or an error has occurred in the application due to inadequacy of the input document. The process then proceeds to step S1308.

In step S1308, the application control unit 20 forcibly terminates the process of the conversion application. According to the second exemplary embodiment, the process of forcible termination includes the following series of processing described above with reference to FIG. 12C.

The application control unit 20 increments by 1 the count of the number of times of time-out in the job mode illustrated in FIG. 12A.

If the number of times of time-out in the job mode does not match the number of times of activation in the job mode, the application control unit 20 enters a sleep mode and waits for the number of times of time-out in the job mode to match the number of times of activation in the job mode.

If the number of times of time-out in the job mode matches the number of times of activation in the job mode by incrementing the count of the number of times of time-out in the job mode by 1, the application control unit 20 forcibly terminates the process of the application.

In step S1309, the application control unit 20 shifts the mode from the job mode to the page mode.

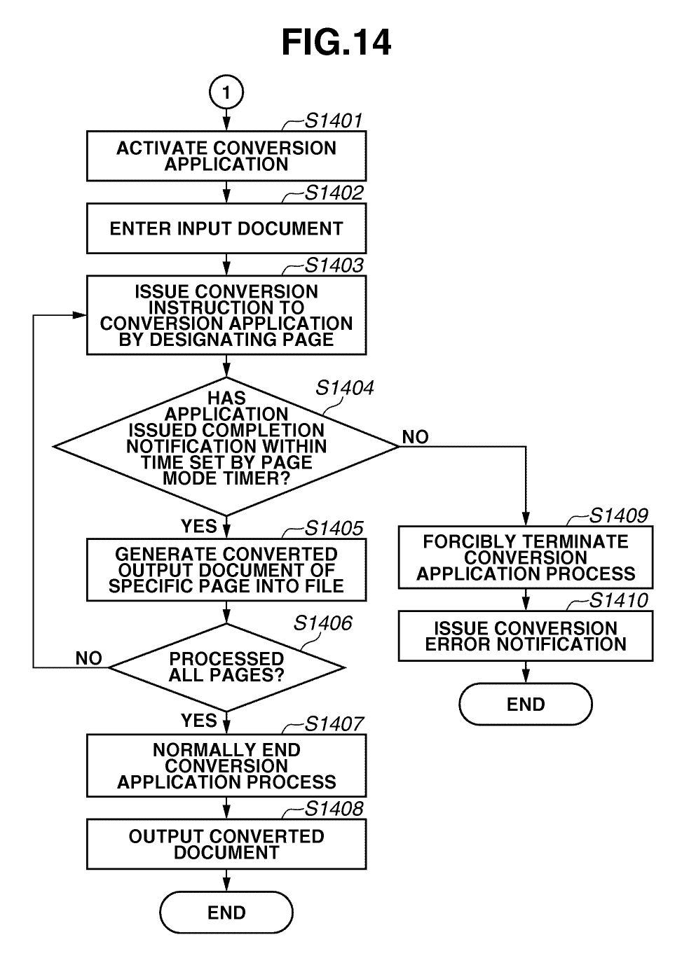

The process performed in the page mode after shifting from the job mode as illustrated in FIG. 13 will be described below with reference to a flowchart illustrated in FIG. 14.

Referring to FIG. 14, the page mode illustrated in FIG. 6B is designated. Further, the input document and the output conversion instruction acquired by the input-output management unit 19 in step S1301 illustrated in FIG. 13 can be directly utilized in the processing of the flowchart illustrated in FIG. 14.

In step S1401, the application control unit 20 activates the application capable of converting the input document. According to the second exemplary embodiment, the activation processing includes the following series of processing described above with reference to FIG. 12C.

The application control unit 20 reads the process ID of the application.

The application control unit 20 accesses the shared information illustrated in FIG. 12A, using the process ID. If the number of times of activation in the page mode is 0, the application control unit 20 activates the process of the application.

The application control unit 20 increments the number of times of activation in the page mode by 1.

The above-described conversion application is similar to the application in step S1302 illustrated in FIG. 13. In step S1402, the application control unit 20 causes the activated application to read the input document.

In step 1403, since the page mode is currently designated, the document conversion page mode instruction unit 22 instructs the application to directly convert the input document to the output document, or to issue the print instruction to the output document generation printer driver. In such a case, the document conversion page mode instruction unit 22 issues instructions to convert one page of the input document to one output document.

The application control unit 20 measures the time for the application to issue a response of completing the processing. Since the current setting is the page mode, the application control unit 20 monitors whether there is a response from the application within the time set to the page mode timer registered as illustrated in FIG. 12B.

In step S1404, the application control unit 20 thus determines whether the completion notification has been issued by the application within the time set to the page mode timer. If the application has issued the completion notification within the time set to the page mode timer (YES in step S1404), it indicates that the application has normally completed the output document conversion. The processing then proceeds to step S1405. In step S1405, the document conversion page mode instruction unit 22 converts the output document of the designated page into a file. In step S1406, the document conversion page mode instruction unit 22 determines whether all of the pages in the input document have been processed.

If the document conversion page mode instruction unit 22 determines that not all of the pages in the input document has been processed (NO in step S1406), the processing returns to step S1403. In step S1403, the document conversion page mode instruction unit 22 designates the subsequent page as the page to be converted, and re-instructs the designated page to be converted to an output document. In step S1404, the application control unit 20 performs comparison between the response time and the time set to the page mode timer. If the designated page is normally converted, the processing proceeds to step S1405 in which the document conversion page mode instruction unit 22 converts the output document into a file. The above-described processing is performed for every page until all pages in the input data have been converted.

If all of the designated pages have been converted into the output documents within the time set to the page mode timer (YES in step S1406), it indicates that the input document has been normally converted to the output document.

In step S1407, the application control unit 20 normally ends the process of the conversion application activated in step S901. According to the second exemplary embodiment, the process normal end processing includes the following series of processing described above with reference to FIG. 12C.

The application control unit 20 decrements the number of times of activation in the page mode by 1.

If the number of times of activation in the page mode becomes 0 by decrementing, the application control unit 20 normally ends the process of the application.

In step S1408, the input-output management unit 19 associates the output documents of the designated pages corresponding to the number of pages in the input document generated by the conversion application, or the conversion application and the output document generation printer driver. The input-output management unit 19 associates the output documents of the designated pages as illustrated in FIG. 6C. The input-output management unit 19 thus generates the document.

If the application which is converting a specific page does not issue the completion notification within the time set to the page mode timer (NO in step S1404), it indicates that an error has occurred in the application due to inadequacy of the input document of the specific page. In such a case, the input document cannot be converted to the output document. The processing then proceeds to step S1409.

In step SS1409, the application control unit 20 forcibly terminates the process of the conversion application. According to the second exemplary embodiment, the forcible termination processing includes the following series of processing described above with reference to FIG. 12C.

The application control unit 20 increments by 1 the count of the number of times of time-out in the page mode illustrated in FIG. 12A.

If the number of times of time-out in the page mode does not match the number of times of activation in the page mode, the application control unit 20 enters the sleep mode and waits for the number of times of time-out in the page mode to match the number of times of activation in the page mode.

If the number of times of time-out in the page mode matches the number of times of activation in the page mode by incrementing the count of the number of times of time-out in the page mode by 1, the application control unit 20 forcibly terminates the process of the application.

In step S1410, the input-output management unit 19 transmits the processing error notification indicating that the instructed conversion processing has failed.

As described above, error determination can be performed at high speed even when a plurality of document conversion units uses the same conversion application in parallel.

The present invention may be realized by supplying software (i.e., a program code) for implementing functions of the above-described exemplary embodiments to a system or an apparatus via a network or various storage media, and a computer (or a CPU or a micro processing unit (MPU)) in the system or the apparatus reading and executing the program code.

According to the above-described exemplary embodiments, a failure or an error in the processing may be processed in a short time even when an error occurs in the application and there is no response.

In other words, an input document which includes a large number of pages and conversion requires time can be normally processed. At the same time, a failure or an error in the processing may be processed in a short time even when an error occurs in the application and there is no response.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-109515 filed May 16, 2011, which is hereby incorporated by reference herein in its entirety.

What is claimed is:

1. A document conversion apparatus including a document conversion processing unit configured to control an application that converts a document, the document conversion processing unit comprising:
a job mode instruction unit configured to instruct an application to perform conversion in a job mode in which an entire document is collectively converted;
an application control unit configured to activate a process of an application and determine whether a response indicating that conversion has been completed is received from the application within a time set to a job mode timer corresponding to the job mode; and
a page mode instruction unit configured to instruct, when the application control unit determines that no response indicating that conversion has been completed is received from the application within the time set to the job mode timer, the application to perform conversion in a page mode in which the entire document is converted page by page to a document corresponding to a number of pages,
wherein the application control unit further determines whether a response indicating that conversion has been completed is received from the application within a time set to a page mode timer corresponding to the page mode, and when no response indicating that conversion has been completed is received from the application within the time set to the page mode timer, forcibly terminates a process of the application.

2. The document conversion apparatus according to claim 1, wherein the document conversion processing unit further comprising an error notification unit configured to notify, when the application control unit forcibly terminates the process of the application, a failure in converting the document.

3. The document conversion apparatus according to claim 2, wherein the error notification unit outputs, along with the notification of a failure in converting the document, information on pages that have been successfully converted and pages that have failed to be converted.

4. The document conversion apparatus according to claim 1, wherein the document conversion processing unit further comprising an output unit configured to output, when the application control unit determines that a response indicating that conversion has been completed is received from the application within the time set to the job mode timer, a document converted by the application.

5. The document conversion apparatus according to claim 4, wherein the page mode instruction unit converts, when the application control unit determines that a response indicating that conversion has been completed is received from the application within the time set to the page mode timer, the converted document into a file, and
wherein the output unit outputs, when it is determined that all pages have been converted, the document converted into a file.

6. A document conversion apparatus including a plurality of document conversion processing units configured to control an application that converts a document, the document conversion processing unit comprising:
a job mode instruction unit configured to instruct an application to perform conversion in a job mode in which an entire document is collectively converted;
an application control unit configured to determine whether response indicating that conversion has been completed is received from the application within time set to a job mode timer corresponding to the job mode, and increments by 1, if the application control unit determines that no response indicating that conversion has been completed is received from the application within the time set to the job mode timer, a count of a number of times of activation in a job mode which has run out of time, stored in a storage area shared by the plurality of document conversion units; and
a page mode instruction unit configured to instruct, if the application control unit determines that no response indicating that conversion has been completed is not received from the application within the time set to the job mode timer, and the count of the number of times of activation in the job mode which has run out of time, stored in the shared storage area, matches the count of the number of times of activation in the job mode, the application to perform conversion in the page mode in which an entire document is converted page by page to a document corresponding to a number of pages,
wherein the application control unit further determines whether a response indicating that conversion has been completed is received from the application within time set to the page mode timer corresponding to the page mode, increments by 1, if no response that conversion has been completed is received from the application within the time set to the page mode timer, the count of the number of times of activation in the page mode which has run out of time, stored in the shared storage area, and forcibly terminates, if the count of the number of times of activation in the page mode which has run out of time matches the count of the number of times of activation in the page mode as a result of incrementing, a process of the application.

7. The document conversion apparatus according to claim 6, wherein the application control unit increments by 1, if the job mode instruction unit instructs conversion in the job mode, the count of the number of times of activation in the job mode, and increments by 1, if the page mode instruction unit instructs conversion in the page mode, the count of the number of times of activation in the page mode.

8. An information processing method comprising:
instructing an application to convert a document in a job mode in which an entire document is collectively converted;
activating a process of an application and determining whether a response indicating that conversion has been completed is received from the application within time set to a job mode timer corresponding to the job mode;
instructing, if it is determined that no response indicating that conversion has been completed is received from the application within the time set to the job mode timer, the application to perform conversion in a page mode in which an entire document is converted page by page to a document corresponding to a number of pages; and
determining whether a response indicating that conversion has been completed is received from the application within time set to a page mode timer corresponding to the page mode, and if no response indicating that conversion has been completed is received from the application within the time set to the page mode timer, forcibly terminating a process of the application.

9. An information processing method comprising:
instructing an application to convert a document in a job mode in which an entire document is collectively converted;
determining whether a response indicating that conversion has been completed is received from the application within time set to a job mode timer corresponding to the job mode, and incrementing by 1, if it is determined that no response indicating that conversion has been completed is received from the application within the time set to the job mode timer, a count of a number of times of activation in a job mode which has run out of time, stored in a storage area shared by the plurality of document conversion units;
instructing, if it is determined that no response indicating that conversion has been completed is received from the application within the time set to the job mode timer, and a count of the number of times of activation in a job mode which has run out of time, stored in the shared storage area, matches a count of a number of times of activation in a job mode, the application to perform conversion in a page mode in which an entire document is converted page by page to a document corresponding to a number of pages; and
determining whether a response indicating that conversion has been completed is received from the application within time set to a page mode timer corresponding to the page mode, incrementing by 1, if response indicating that conversion has been completed is received from the application within the time set to the page mode timer, a count of a number of times of activation in a page mode which has run out of time, stored in the shared storage area, and forcibly terminating, if a count of a number of times of activation in a page mode which has run out of time matches a count of a number of times of activation in a page mode as a result of incrementing, a process of the application.

10. A non-transitory computer-readable storage medium storing a program for causing a computer to perform a method, the method comprising:
instructing an application to convert a document in a job mode in which an entire document is collectively converted;
activating a process of an application and determining whether a response indicating that conversion has been completed is received from the application within time set to a job mode timer corresponding to the job mode;
instructing, if it is determined that no response indicating that conversion has been completed is received from the application within the time set to the job mode timer, the application to perform conversion in a page mode in which an entire document is converted page by page to a document corresponding to a number of pages; and
determining whether a response indicating that conversion has been completed is received from the application within time set to a page mode timer corresponding to the page mode, and if no response indicating that conversion has been completed is received from the application within the time set to the page mode timer, forcibly terminating a process of the application.

11. A non-transitory computer-readable storage medium storing a program for causing a computer to perform a method, the method comprising:
instructing an application to convert a document in a job mode in which an entire document is collectively converted;
determining whether a response indicating that conversion has been completed is received from the application within time set to a job mode timer corresponding to the job mode, and incrementing by 1, if it is determined that no response indicating that conversion has been completed is received from the application within the time set to the job mode timer, a count of a number of times of activation in a job mode which has run out of time, stored in a storage area shared by the plurality of document conversion units;
instructing, if it is determined that no response indicating that conversion has been completed is received from the application within the time set to the job mode timer, and a count of the number of times of activation in a job mode which has run out of time, stored in the shared storage area, matches a count of a number of times of activation in a job mode, the application to perform conversion in a page mode in which an entire document is converted page by page to a document corresponding to a number of pages; and
determining whether a response indicating that conversion has been completed is received from the application within time set to a page mode timer corresponding to the page mode, incrementing by 1, if no response indicating that conversion has been completed is received from the application within the time set to the page mode timer, a count of a number of times of activation in a page mode which has run out of time, stored in the shared storage area, and forcibly terminating, if a count of a number of times of activation in a page mode which has run out of time matches a count of a number of times of activation in a page mode as a result of incrementing, a process of the application.
